(19) United States
(12) Patent Application Publication
(10) Pub. No.: US 2026/0330660 A1
(43) Pub. Date: Oct. 22, 2026

(54) METHODS AND APPARATUS FOR FUSED MODE NIGHT VISION

(71) Applicant: Rivet Industries, Inc., Washington, DC (US)

(72) Inventors: Jouya JADIDIAN, Los Gatos, CA (US); Seyedsohrab MADANI, Menlo Park, CA (US); Afshin ZADE, Menlo Park, CA (US); Calin CRISTIAN, Iasi (RO); Shubham GUPTA, New York, NY (US)

(21) Appl. No.: 19/648,941

(22) Filed: Apr. 15, 2026

Related U.S. Application Data
(60) Provisional application No. 63/791,298, filed on Apr. 18, 2025.

(51) Int. Cl. G06T 7/33; G06T 7/13; G06T 7/50; G06V 10/25; G06V 10/764; H04N 23/11; H04N 23/13; H04N 23/90

(52) U.S. Cl. CPC G06T 7/337; G06T 7/13; G06T 7/50; G06V 10/25; G06V 10/764; H04N 23/11; H04N 23/13; H04N 23/90; G06T 2207/10048; G06T 2207/20081; G06T 2207/20221

(57) ABSTRACT

An apparatus includes a thermal camera configured to capture a thermal image frame of an environment. The apparatus includes a low light camera configured to capture a low light image frame of the environment. The apparatus includes a compute device including a display, a processor, and a memory. The compute device is communicatively coupled to the thermal camera and the low light camera. The memory stores instructions that cause the processor to detect a plurality of edges in the thermal image frame. The processor is also caused to align the low light image frame to the plurality of edges in the thermal image frame to produce an image stack. The processor is also caused to cause the display to display a composite image frame based on the image stack in substantially real-time relative to receiving at least one of the thermal image frame or the low light image frame.

### CROSS REFERENCE TO RELATED APPLICATION

This application claims priority to U.S. Provisional Patent Application No. 63/791,298, filed on Apr. 18, 2025 and titled, “Methods and Apparatus for Fused Mode Night Vision,” the entirety of which is incorporated herein by reference.

### FIELD

The present disclosure generally relates to imaging, and more specifically to methods and apparatus for improving spatial resolution of images.

### BACKGROUND

A capability of an imaging system to resolve fine details is limited by diffraction, which causes light waves to spread out as they pass through an aperture. Longer wavelengths of light can diffract more than shorter wavelengths of light, which can cause imaging systems using longer wavelengths of light to form images with less spatial resolution than imaging systems using shorter wavelengths of light. For example, thermal images can have lower spatial resolution than visible light images, resulting in blurred edges and little detail of a physical environment. Challenges remain to improve spatial resolution for imaging systems that use thermal cameras in low light environments, which can be a desirable imaging modality for various applications such as search and rescue, industrial inspections, or security. Thus, a need exists to improve spatial resolution for imaging systems that use thermal cameras in, for example, low light environments.

### SUMMARY

In some embodiments, an apparatus includes a thermal camera configured to capture a thermal image frame of an environment. The apparatus also includes a low light camera configured to capture a low light image frame of the environment. The apparatus also includes a compute device including a display, a processor, and a memory. The compute device is communicatively coupled to the thermal camera and the low light camera. The memory stores instructions that when executed by the processor cause the processor to detect, based on the thermal image frame, a plurality of edges in the thermal image frame. The memory also stores instructions that cause the processor to align, based on the thermal image frame, the low light image frame to the plurality of edges in the thermal image frame to produce an image stack. The memory also stores instructions that cause the processor to cause the display to display a composite image frame based on the image stack in substantially real-time relative to receiving at least one of the thermal image frame or the low light image frame.

In some embodiments, a method includes producing a first image stack that captures a representation of an environment. Producing the first image stack is based on a first image frame from a first low light camera and a second image frame from a second low light camera. The method also includes producing a classification for an object in a third image frame based on inputting the third image frame into a machine learning model. The third image frame captures a representation of the environment from a thermal camera. The method also includes calculating a depth value of the object in the third image frame. Calculating the depth value is based on a size of a bounding box in the third image frame. The bounding box is associated with the object. Calculating the depth value is also based on the classification. Calculating the depth value is also based on an optical parameter of the thermal camera. The method also includes detecting, based on the third image frame, a plurality of edges in the third image frame. The plurality of edges includes edges of the object. The method also includes aligning, based on the third image frame, the first image stack to the plurality of edges in the third image frame to produce a second image stack. The method also includes sending a signal to a display to cause the display to display a composite image frame based on the second image stack. The composite image frame includes a representation of at least one of the classification or the depth value. The representation is overlayed in the composite image frame in substantially real-time relative to receiving at least one of the first image frame, the second image frame, or the third image frame.

In some embodiments, a non-transitory, processor-readable medium stores instructions that, when executed by a processor, cause the processor to receive a thermal image frame from a thermal camera operatively coupled to the processor. The non-transitory, processor-readable medium also stores instructions that cause the processor to receive a plurality of visible light image frames from a plurality of visible light cameras operatively coupled to the processor. The non-transitory, processor-readable medium also stores instructions that cause the processor to classify, based on inputting the thermal image frame into a machine learning model, an object in the thermal image frame to produce an object classification. The non-transitory, processor-readable medium also stores instructions that cause the processor to calculate a depth value of the object in the thermal image frame. Calculating the depth value is based on a size of a bounding box in the thermal image frame. The bounding box is associated with the object. Calculating the depth value is also based on the object classification. Calculating the depth value is also based on an optical parameter of the thermal camera. The non-transitory, processor-readable medium also stores instructions that cause the processor to align, based on the thermal image frame, the plurality of visible light image frames to the object in the thermal image frame to produce an image stack. The non-transitory, processor-readable medium also stores instructions that cause the processor to send a signal to cause a display to display a composite image frame based on the image stack. The composite image frame has a representation of at least one of the object classification or the depth value. The composite image frame has the representation in substantially real-time relative to receiving at least one of the thermal image frame or the plurality of visible light image frames.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an imaging system for fused mode night vision, according to an embodiment.

FIG. 2 shows example image outputs from an object detector, according to an embodiment.

FIG. 3 shows example image outputs from a depth estimator, according to an embodiment.

FIG. 4 shows multiple example image outputs from an imaging system for fused mode night vision, according to some embodiments.

FIG. 5 shows a flow diagram of an example method for fused mode night vision, according to an embodiment.

FIG. 6 shows a flow diagram of a method for fused mode night vision, according to an embodiment.

FIG. 7 shows a flow diagram of a method for fused mode night vision, according to an embodiment.

### DETAILED DESCRIPTION

One or more embodiments of the present disclosure relate to systems and methods for processing images from multiple cameras/imagers and for rendering composite images on a display. In combining multiple imaging modalities for a low light environment, one or more embodiments of the present disclosure can also be referred to herein as systems and methods for fused mode night vision, or simply as fused mode night vision. Devices that implement fused mode night vision can include thermal cameras, low light cameras, and/or visible light cameras, which can produce thermal images, low light images, and visible light images, respectively, that each includes the same object in a low light environment. It may be desirable for a user of a device that implements fused mode night vision to continuously view, monitor, and/or react to objects in a low light environment and that, in some instances, can have a high heat signature relative to other objects in the low light environment. In such instances, objects with identifiable heat signatures can be more identifiable in thermal images than in visible light images, to a user and/or to a device configured to detect object.

In contrast to known systems, devices that implement fused mode night vision can detect, classify, and estimate a depth for the object in thermal images in substantially real-time (e.g., with little to no perceivable delay relative to receiving an image; less than 50 ms) to provide substantially real-time feedback about the object to a user. Devices that implement fused mode night vision can align low light images to features in the thermal images and render a composite image with more information about a low light environment compared to individual images alone. In contrast to known systems, devices that implement fused mode night vision can display information about the object (e.g., a depth value based on the object classification) in a composite image in substantially real-time. In some instances, the composite images can include graphic overlays of visual indicators (e.g., icons, shapes, text, colors, etc.) associated with one or more objects and/or edges of the one or more objects to emphasize portions of the composite images to a user (or viewer).

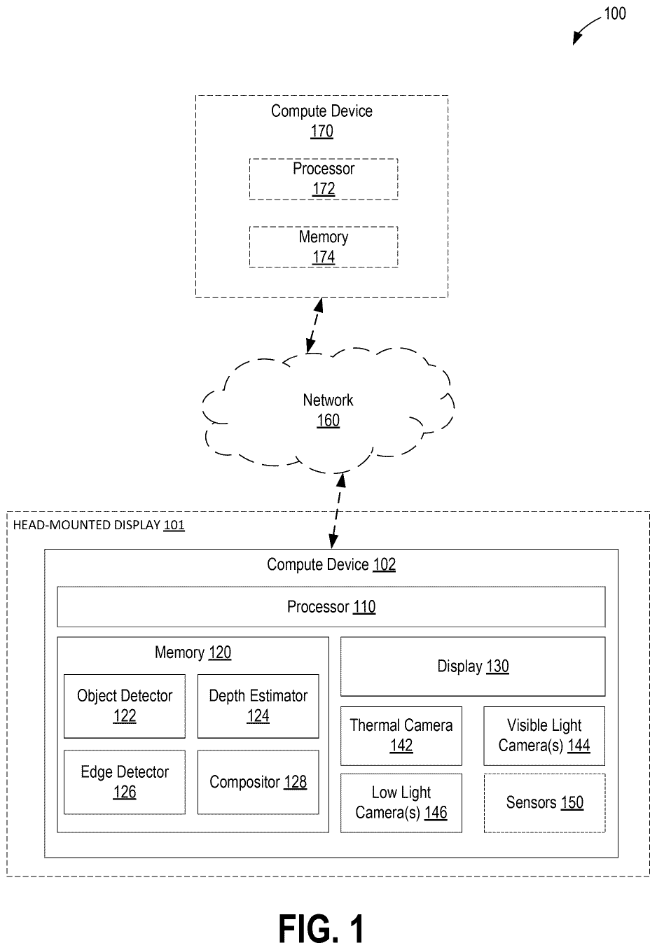

FIG. 1 is a block diagram of an imaging system 100 for fused mode night vision, according to an embodiment. The imaging system 100 includes a compute device 102 and optionally includes a network 160 and a compute device 170. In some implementations, the compute device 102 and the compute device 170 are communicatively coupled via the network 160.

The compute device 102 can be and/or include any suitable hardware-based computing device configured to capture data representing information about a local environment, store data, and display data to a user of the compute device 102. For example, the compute device 102 can be included in a head mounted display 101, an augmented reality (AR) or mixed reality (MR) device (e.g., a headset, glasses, goggles, etc. that is configured to be worn by a user), a personal computer (PC), a workstation, a smartphone, a smart television, a smartwatch, a tablet, a laptop computer, and/or the like. In some implementations, the compute device 102 can receive inputs and/or data directly from a user interacting with the compute device 102 (e.g., via peripheral components such as a microphone, touchscreen, etc.). The compute device 102 includes a processor 110, a memory 120, a display 130, a thermal camera 142, one or more visible light camera(s) 144, one or more low light camera(s) 146, a communications interface (not shown), and optionally includes sensors 150. The processor 110, the memory 120, the display 130, the thermal camera 142, the one or more visible light camera(s) 144, the one or more low light camera(s) 146, and the sensors 150 can be communicatively coupled together for example by wired connection or wireless connection.

The thermal camera 142 can be, for example, a device that produces images (also referred to herein as thermal images) and/or image feeds of a video, by detecting thermal infrared (IR) radiation. Thermal IR radiation can include, for example, light having a wavelength from a mid-wave infrared spectral band (e.g., about 3 microns to about 5 microns) and/or light having a wavelength from a long-wave infrared spectral band (e.g., about 8 microns to about 14 microns). The image feeds can be composed of multiple image frames. The thermal images can be sized to reduce a latency of the imaging system 100. For example, the thermal images can be sized to 480 pixels by 640 pixels. The thermal camera 142 can also be referred to as a thermographic camera, a thermal imager, a thermal imaging camera, and/or an IR camera. The thermal camera 142 can be, for example, a monocular thermal camera. The thermal camera 142 can include detectors such as, for example, cooled detectors or uncooled detectors.

The visible light camera(s) 144 can be, for example, a device that produces images (also referred to herein as visible light images) and/or image feeds of a video, by detecting (reflected) visible light (or at least a portion of the visible light spectrum) using sensors. The image feeds can be composed of multiple image frames. The visible light camera(s) 144 can include sensors such as, for example, single-photon avalanche sensors, complementary metal-oxide semiconductor (CMOS) sensors, etc.

The low light camera(s) 146 can be, for example, a device that produces images (also referred to herein as low light images) and/or image feeds of a video, by detecting low-light radiation. Low-light radiation can include, for example, light having a wavelength from a near-infrared spectral band (e.g., about 750 nm to about 1.1 microns). The image feeds can be composed of multiple image frames.

The low light camera(s) 146, the visible light camera(s) 144 and the thermal camera 142 can be co-located in an environment such that at least portions of low light images, at least portions of visible light images and at least portions of thermal images can capture a same scene. Stated another way, the low light camera(s) 146 (and/or the visible light camera(s) 144) can have a field-of-view (FOV) with a region that at least partially overlaps with a region of a FOV of the thermal camera 142 to define a region of overlap between the different FOV's. For example, the compute device 102 can receive a low light image and a thermal image that share a region of overlap that includes the same object(s) (e.g., a human, a vehicle, a vessel, an animal, or other heat source). In computer vision terms, the low light images (or visible light images) and the thermal images can be related by a homography.

In implementations that include the sensors 150, the sensors 150 can include, for example, an inertial measurement unit (IMU), an accelerometer, a gyroscope, a Global Positioning System (GPS) sensor, a WiFi® sensor (e.g., a WiFi® receiver or a WiFi® transceiver), a radar sensor, a magnetometer, etc. In some implementations, for example, the compute device 102 can be included in a head mounted display (HMD) 101 or other wearable devices with sensors 150 for tracking a position and rotation of a user wearing the HMD. In some such implementations, the compute device 102 can, for example, send data such as GPS coordinates of the user to the compute device 170 via the network 160.

The processor 110 can be a hardware-based integrated circuit (IC) and/or any other suitable processing device configured to run or execute a set of instructions and/or code stored, for example, in the memory 120. For example, the processor 110 can be a general-purpose processor, a central processing unit (CPU), a graphics processing unit (GPU), an accelerated processing unit (APU), an application specific integrated circuit (ASIC), a network processor, a field programmable gate array (FPGA), a programmable logic array (PLA), and/or the like. For example, the processor 110 can be a processor with half-precision floating-point (e.g., Qualcomm® SM8550, etc.) or with low precision integer support. A processor with low precision integer support can reduce a memory usage and facilitate faster compute time for the imaging system 100 relative to a processor with high precision floating-point support, which can facilitate the substantially real-time delivery of information about an environment local to the compute device 102, including objects therein, to the display 130. The processor 110 can be in communication with the memory 120 via any suitable interconnection, system bus, circuit, and/or the like. As described in further detail herein, the processor 110 can include any number of engines, processing units, cores, etc. configured to execute code, instructions, modules, processes, and/or functions associated with receiving images, detecting and/or classifying objects in images, estimating depth of objects in images, detecting edges (or other features) in images, aligning images, generating composite images, and/or rendering composite images on the display 130.

The memory 120 can be or include a stack memory, a cache memory, a random-access memory (RAM), a memory buffer, a magnetic disk (e.g., hard drive memory), a read-only memory (ROM), a semiconductor-based storage device (e.g., a solid-state drive), an erasable programmable read-only memory (EPROM), a flash memory, and/or the like. The memory 120 can be configured to store, for example, one or more software modules and/or code that can include instructions that can cause the processor 110 to perform one or more processes, functions, and/or the like. The memory 120 includes an object detector 122, a depth estimator 124, an edge detector 126, and a compositor 128, each of which can facilitate the substantially real-time delivery of information about an environment local to the compute device 102, including objects therein, to the display 130.

The object detector 122 can be, for example, a machine learning model such as a convolutional neural network (CNN) (e.g., a region-based CNN, a single-shot detector such as You Only Look Once (YOLO), etc.), a transformer (e.g., a detection transformer (DETR), etc.), or any other machine learning model suitable for detecting and/or classifying objects in images in substantially real-time (e.g., with little to no perceivable delay relative to receiving an image; less than 50 ms). In some implementations, the object detector 122 can be a machine learning model configured to detect objects in a range of 5-10 ms, a range of 5-15 ms, a range of 13-17 ms, in a range of 10-20 ms, etc., such as a single-shot detector. A single-shot detector can perform object detection in a single forward pass through a CNN, which can often be less computationally expensive than performing object detection in multiple passes of a region-based CNN. As described in further detail herein, the object detector 122 can cause the processor 110 to display representations of information about objects in images on the display 130.

In some implementations, the object detector 122 can be, for example, a supervised machine learning model. Before use (e.g., before an inference phase, or between inference phases), the processor 110 can input labeled images to train the supervised machine learning model of the object detector 122. The processor 110 can scale pixel values of images (e.g., the labeled images) to a predefined range to improve the performance and efficiency of the object detector 122. The labeled images can include a bounding box for each object and/or a classification for each bounding box in the image. For example, the labeled images can be labeled thermal images that represent temperature variations (or profiles) of objects in an environment (e.g., humans, animals, or other heat sources). In some implementations, a user of the compute device 102 can assign the bounding boxes for each object in the labeled thermal images. In some implementations, the compute device 170 can train the machine learning model of the object detector 122 to produce a trained machine learning model. In some implementations, the compute device 102 can receive the trained machine learning model of the object detector 122 from the compute device 170 via the network 160 and can store the trained machine learning model of the object detector 122 at the memory 120.

The object detector 122 can produce object detections in response to receiving an image such as, for example, a thermal image from the thermal camera 142. An object detection can be, for example, a group of pixels in the image processed by the object detector 122 that the object detector 122 identifies to be associated with an imaged object. The object detector 122 can represent each object prediction as a bounding box or other suitable representation in the thermal image. The object detector 122 can store a confidence value for each bounding box at the memory 120 (e.g., in a database). The confidence value can be, for example, a score that represents how likely a bounding box contains an object. The object detector 122 can calculate a confidence score by, for example, multiplying a probability that the thermal image includes an object by an intersection over union (IOU) value between the bounding box in the thermal image and bounding boxes in the labeled thermal images that contain the object.

In some implementations, the object detector 122 can produce multiple bounding boxes for a singular object and store a confidence value for each of the multiple bounding boxes. The object detector 122 can calculate IOU values among the multiple bounding boxes and compare the IOU values to a predefined IOU threshold value that, when met, can cause the object detector 122 to determine the multiple bounding boxes to be duplicates. The object detector 122 can compare the confidence values among the duplicate bounding boxes and can identify a bounding box from the duplicate bounding boxes that has the highest confidence value. The object detector 122 can delete (e.g., remove, etc.) all duplicate bounding boxes except for the bounding box with the highest confidence value.

In some implementations, the object detector 122 can cause the processor 110 to display (or restrict display of) a visual indicator (e.g., a bounding box, etc.) that represents the relative location of an object detection in the associated image frame, based on the classification of the object. For example, the object detector 122 can cause display of a visual indicator when a classification type of an associated object detection substantially matches a predefined classification type from a predefined set of classification types (e.g., humans, vehicles, vessels, animals, etc.). Similarly, the object detector 122 can cause the processor 110 to restrict display of a visual indicator when a classification type of an associated object detection does not match a predefined classification type from the predefined set of classification types. Instead, or in addition, the object detector 122 can cause display of a visual indicator when a classification type of an associated object detection has a predefined priority value that meets and/or exceeds a predefined threshold value. Similarly, the object detector 122 can cause the processor 110 to restrict display of a visual indicator when a classification type of an associated object detection has a predefined priority value that does not meet and/or does not exceed a predefined threshold value. For example, a human classification type can have a priority value higher than a priority value of a non-human classification type, and, in some instances, the priority value of the human classification type can exceed a predefined threshold value while the priority value of the non-human classification type does not exceed the predefined threshold value, causing display of visual indicators that represent humans and causing restriction of display of visual indicators that represent non-humans.

The object detector 122 can store data associated with the object detection and/or the visual indicator at the memory 120, such as, for example, a cropped image including the object, a length value of a bounding box and/or a width value of a bounding box, a confidence value for the object detection, a classification associated with the object detection, etc.). In some implementations, the object detector 122 can overlay multiple visual indicators associated with the object detection in the thermal image. The visual indicators can be and/or include, for example, a dot, a shape, a color, a saturation, a brightness, a resolution, and/or the like to emphasize the portion of the thermal image with the object. In some instances, the object detector 122 can cause the processor 110 to overlay a different visual indicator for each object detection in the thermal image based on the classification of each object. For example, the object detector 122 can cause the processor 110 to overlay a geometric shape (e.g., a rectangle, a square, a triangle, etc.) on one object detection when the classification type is a human, and a dot for another object detection when the classification type is a car.

The depth estimator 124 can be or include one or more software modules and/or hardware suitable for calculating depths of objects detected in images. For example, the depth estimator 124 can be a software module and can include a set of instructions that can cause the processor 110 to calculate a depth of an object in a thermal image. In contrast to known systems that use depth cameras, the depth estimator 124 can cause the processor 110 to perform rapid depth calculations based on the classification of the object, which can facilitate the substantially real-time delivery of information to the display 130. The depth estimator 124 can receive the thermal image with a bounding box containing the object from the object detector 122. The processor 110 can calculate (e.g., estimate) the depth of the object using, for example, a width of the bounding box (e.g., a width value stored at the memory 120), a focal length of the thermal camera 142 (e.g., a focal length stored as a value at the memory 120), and an estimated width of the object (e.g., an estimated width of the object stored as a measurement value at the memory 120), according to equation 1:

$${Depth}_{object} = \frac{{width}_{object} * focal {length}_{t h ermal camera}}{{width}_{b o u nding box}} \qquad ( Equation 1 )$$

In some implementations, the processor 110 can calculate a depth of the object based exclusively on (i) the width of the bounding box (e.g., a width value stored at the memory 120), (ii) the focal length of the thermal camera 142 (e.g., a focal length stored as a value at the memory 120), and (iii) the estimated width of the object (e.g., an estimated width of the object stored as a measurement value at the memory 120). For example, the processor 110 can calculate a depth of the object based solely on equation 1 and not based on other features captured in or information represented by the thermal image, such as features of multiple different objects. In some implementations, the processor 110 can predefine estimated widths for multiple objects to facilitate faster computations. In response to receiving a thermal image with an object detection, the depth estimator 124 can retrieve a classification of the object from the memory 120 and, based on the classification, can retrieve the associated predefined estimated width for the object. For example, the processor 110 can predefine a width for a human as about 0.61 meters, a bicycle as about 1.75 meters, a car as about 4 meters, a truck as about 17.5 meters, etc. and can store the widths as values in the memory 120 at a time before processing a thermal image from the thermal camera 142. The depth estimator 124 can use, for example, 0.61 meters, as a proxy value for objects classified as humans in the thermal image to facilitate faster depth calculations. Similarly, the depth estimator 124 can use, for example, 1.75 meters, 4 meters, and 17.5 meters, as proxy values for objects classified as bicycles, cars, and trucks, respectively. The depth estimator 124 can store data such as calculated depth values for objects at the memory 120 (e.g., in feet, yards, meters, etc.). In some implementations, the depth estimator 124 can include instructions to cause the processor 110 to overlay text representing a depth of an object within the thermal image to produce a thermal image including a bounding box of an object and text representing the depth of the object.

In some implementations, the depth estimator 124 can cause the processor 110 to display (or restrict display of) depth values in the associated image frame, based on the estimated depth of the object. For example, the depth estimator 124 can compare a depth value of an object to a predefined threshold value. The depth estimator 124 can cause the processor 110 to display a depth value that meets or surpasses the predefined threshold value. Similarly, the object detector 122 can cause the processor 110 to not display a depth value of an object that does not meet or surpass the predefined threshold value.

In some implementations, the depth estimator 124 can cause the processor 110 to overlay a different visual indicator for each object detection in the thermal image based on the depth value of each object. For example, the depth estimator 124 can cause the processor 110 to overlay a geometric shape (e.g., a rectangle, a square, a triangle, etc.) for one object detection when the depth value of the associated object is less than a predefined threshold value, and a dot for another object detection when the depth value of the associated object is greater than the predefined threshold.

The edge detector 126 can be or include one or more software modules and/or hardware suitable for detecting edges in images. For example, the edge detector 126 can be a software module and can include a set of instructions that when executed by the processor 110 can cause the processor 110 to detect edges in an image, such as a thermal image. The edge detector 126 can receive a thermal image from, for example, the depth estimator 124 and can detect edges in the thermal images using one or more functions and/or image processing techniques, as described herein. The edges can be more prominent for objects (e.g., heat sources) detected in the thermal images relative to a background in the thermal images.

The edge detector 126 can cause the processor 110 to smooth the thermal image (e.g., reduce noise, etc.) using a smoothing function and/or technique such as, for example, a median filter, a gaussian filter, a bilateral filter, a non-local means filter, and/or the like.

The edge detector 126 can cause the processor 110 to calculate pixel intensity gradients of the thermal image in both a horizontal gradient direction (e.g., along a length of the thermal image) and a vertical gradient direction (e.g., along a height of the thermal image) using, for example, a Sobel operator, a Prewitt operator, a Roberts filter, a Laplacian operator, a Scharr filter, and/or the like. The pixel intensity gradients can measure a rate of change in a pixel intensity across the thermal image. The pixel intensity gradients can have a magnitude and a direction.

The edge detector 126 can cause the processor 110 to compare pixel intensity gradients that have a same direction in a local pixel neighborhood to determine the gradient(s) that are local maxima (e.g., gradient(s) with the highest magnitude(s)) in the local pixel neighborhood. The edge detector 126 can cause the processor 110 to suppress any gradient(s) that are not local maxima in the local pixel neighborhood for each local pixel neighborhood in the thermal image. For example, the edge detector 126 can cause the processor 110 to not render gradient(s) that are not local maxima in the local pixel neighborhood in the thermal image, or an intermediate image that includes the gradient(s).

The edge detector 126 can cause the processor 110 to compare the magnitudes of local maxima to magnitude threshold values to determine strong edges and weak edges among the local maxima. In some implementations, a user of the compute device 102 can predefine the magnitude threshold values and cause the processor 110 to store the magnitude threshold values at the memory 120. In some implementations, the edge detector 126 can cause the processor 110 to calculate the magnitude threshold values based on the pixel values in the thermal image using known techniques. The magnitude threshold values can include a high magnitude threshold value and a low magnitude threshold value. The edge detector 126 can cause the processor 110 to determine a local maximum to be a strong edge in response to a magnitude of the local maxima meeting or surpassing the high magnitude threshold value. The edge detector 126 can cause the processor 110 to determine a local maximum to be a weak edge in response to a magnitude of the local maximum meeting and surpassing the low magnitude threshold value but not meeting and not surpassing the high magnitude threshold value. Each strong edge and each weak edge can have endpoints that define the length of the respective edge. The endpoints can be one or more pixels in the thermal image. The pixels of one strong/weak edge can also be pixels of another strong/weak edge, in which case the two strong/weak edges can be understood to be connected.

The edge detector 126 can cause the processor 110 to suppress (e.g., not render) weak edges that are not connected to strong edges. The edge detector 126 can cause the processor 110 to keep (e.g., render) strong edges and weak edges that are connected to strong edges in the thermal image or an intermediate image that includes the edges. The edge detector 126 can thereby produce edges associated with the thermal image and can store data associated with the edges (e.g., pixel coordinates, magnitude, direction, etc.) at the memory 120. The edge detector 126 can cause the processor 110 to overlay the edges in the thermal image and modify a property of the edges to emphasize the edges to a user of the imaging system 100. For example, the edge detector 126 can cause the processor 110 to overlay red edges, thick edges, etc. in the thermal image or in an intermediate image.

The object detector 122, the depth estimator 124, and the edge detector 126 can be pre-processing techniques that, among other things, can extract enough features in a thermal image so that the compositor 128 can match features in a low light image to the edges (or other features) associated with the thermal image to properly align and stitch the low light image and the thermal image together to produce a composite image.

The compositor 128 can be or include one or more software modules and/or hardware suitable for aligning and stitching images to generate composite images. The compositor 128 can receive thermal images from the edge detector 126 and can receive visible light images from the visible light camera(s) 144 and/or low light images from the low light camera(s) 146. The compositor 128 can include any suitable computer vision technique such as, for example, a scale-invariant feature transform (SIFT), a speeded-up robust features (SURF), oriented FAST and rotated BRIEF (ORB), brute-force matcher (BFMatcher), fast library for approximate nearest neighbors (FLANN), accelerated KAZE (AKAZE), and/or the like to match features (e.g., edges, curves, objects, regions, points, etc.) in the low light images (or visible light images) to the edges in the thermal images. The compositor 128 can compute projections from pixel coordinates of the edges in the low light images (or visible light images) to pixel coordinates of the edges in the thermal images and store the projections in a transformation matrix at the memory 120. Using the transformation matrix, the compositor 128 can spatially align the low light images (or visible light images) and the thermal images and produce an (aligned) image stack including the low light images (or visible light images) and the thermal images. The compositor 128 can combine (e.g., merge, fuse, etc.) the low light images (or visible light images) and the thermal images of the (aligned) image stack to produce composite images using spatial domain techniques (e.g., averaging, weighted averaging, etc.), transform domain techniques (e.g., wavelet transform, discrete cosine transform, etc.), region splitting and merging, image stitching, and/or the like.

In some implementations, the compositor 128 can spatially align low light images from multiple low light cameras 146 (or visible light images from multiple visible light cameras 144) with thermal images from the thermal camera 142 to, for example, increase a spatial resolution, increase a brightness or contrast, or otherwise improve a quality of the (aligned) image stack and the resulting composite image. For example, the compositor 128 can spatially align one low light image from one instance of the low light camera(s) 146 with another low light image from another instance of the low light camera(s) 146 to produce an intermediate image stack. The compositor 128 can spatially align the intermediate image stack to the thermal image from the thermal camera 142 to produce an output image stack that can be displayed on the display 130. In some instances, an instance of the low light camera(s) 146 can fail or otherwise become unable to produce images that can be timely aligned. In response, the compositor 128 can produce an intermediate image stack using the low light images of the instances of the low light camera(s) 146 that are operable, and an output image stack using the intermediate image stack and the thermal image from the thermal camera 142. Instead, or in addition, the compositor 128 can be configured to not produce an intermediate image stack and can instead produce an output image stack using an instance of the low light camera(s) 146 that is operable and the thermal camera 142.

In implementations that include the network 160, the network 160 can be any suitable communications network for transferring data, operating over public and/or private communications networks. For example, the network 160 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 160 can be a wireless network such as, for example, a Wi-Fi® or wireless local area network (“WLAN”), a wireless wide area network (“WWAN”), and/or a cellular network. In other instances, the network 160 can be a wired network such as, for example, an Ethernet network, a digital subscription line (“DSL”) network, a broadband network, and/or a fiber-optic network. The communications (e.g., data) sent via the network 160 can be encrypted or unencrypted. In some instances, the network 160 can include multiple networks or subnetworks operatively coupled to one another by, for example, network bridges, routers, switches, gateways and/or the like.

In implementations that include the compute device 170, the compute device 170 can be structurally and/or functionally similar to the compute device 102. The compute device 170 can include a processor 172 and a memory 174 coupled to processor 172. The processor 172 can be structurally and/or functionally similar to the processor 110. The memory 174 can be structurally and/or functionally similar to the memory 120. In some such implementations, the compute device 102 can send data to and/or receive data from the compute device 170 via the network 160. For example, the compute device 170 can include a database, and the compute device 102 can send data to the compute device 170 such as a thermal image, a visible light image, a low light image, a composite image, or data associated with the thermal image, visible light image, a low light image, or composite image (e.g., a depth value, classification, or features of an object, etc.). Moreover, the compute device 170 can send data to the compute device 102, such as a map of an environment (or other information related to an environment) within which the compute device 102 is located, instructions for a user of the compute device 102, and/or the like. The processor 110 can be caused to provide visual feedback representative of such data to a user via the display 130, and/or through other peripheral components (e.g., a speaker; not shown).

In some instances, the compute device 102 can be caused to modify data sent by the compute device 170 to produce modified data, and/or send modified data to the compute device 170. For example, the processor 110 can update a map (e.g., a point cloud, a collection of spatial coordinates, etc.) of the environment with coordinates (e.g., GPS coordinates) that represent a current location of the compute device 102 using the sensors 150. The processor 110 can continuously or repeatedly update the location to establish a motion history of the compute device 102. Instead, or in addition, the processor 110 can be caused to update the map of the environment with coordinates that represent locations of inert (e.g., lacking the ability to move) objects and/or non-inert (e.g., having the ability to move) objects based on object classifications determined by the object detector 122, depth values determined by the depth estimator 124, and sensors 150. For example, the processor 110 can estimate coordinates of an object using a depth value of the object, which represents a relative distance between the compute device 102 and the objects. The processor 110 can update the map to include a representation of the classification associated with each object, coordinates of each object, and/or an indication of whether such objects are a non-inert object (e.g., a human, a vehicle, an animal, etc.) and/or an inert object (e.g., a tree, a boulder, a building, etc.) based on the classifications. The processor 110 can be caused to send an updated map of the environment to the compute device 170 via the network 160, when the network 160 is available and accessible.

In some implementations, the compute device 170 can be a mobile compute device (e.g., a compute device of an unmanned aerial vehicle (UAV) such as a drone, an airplane, a vehicle, and/or of user other than a user of the compute device 102), which can be co-located with the compute device 102 such that the compute device 102 and the compute device 170 can maintain communications via the network 160.

In some implementations, the compute device 102 can generate a map of the environment based on features in the image feeds of the thermal camera 142 and/or the visible light camera(s) 144, and self-locate using, for example, simultaneous location and mapping (SLAM). The compute device 102 can send the map of the environment to the compute device 170 via the network 160.

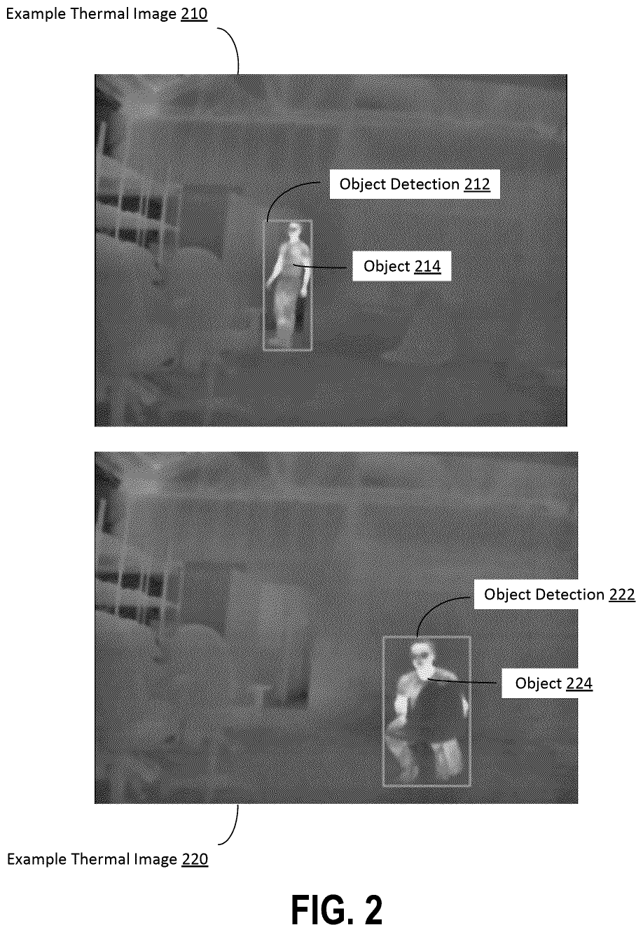

FIG. 2 is an example image output from an object detector, according to an embodiment. The object detector can be functionally and/or structurally similar to the object detector 122 of FIG. 1. The example image output includes an example thermal image 210. The example thermal image 210 includes an object detection 212 and an object 214. The object detector can produce the object detection 212 based on the object 214 (e.g., produced within a range of 5-10 ms after receiving the example thermal image 210). The object detector can cause a processor (e.g., the processor 110 of FIG. 1, not shown in FIG. 2) to overlay a bounding box representing the object detection 212 in the example thermal image 210. The processor can send a signal to cause a display (e.g., the display 130 of FIG. 1, not shown in FIG. 2) to display the example thermal image 210 including a representation of the object detection 212, such as the bounding box. The processor can track the object 214 in subsequent thermal images using, for example, known object tracking techniques. In some instances, an object tracker (not shown) can cause the processor to maintain the object detection 212 (and/or the classification associated with the object detection 212) in subsequent image frames without having to re-detect the object 214. For example, the object tracker can predict motion of the object 214 based on past movement (e.g., via Kalman filters, etc.) to narrow a search window of the subsequent image frames, can match features of the object 214 to features of the substantially same object in the subsequent image frames, and/or other suitable techniques. The processor can send a signal to cause the display to update a position of the object detection 212 in response to receiving subsequent thermal images and identifying the object 214 in the subsequent thermal images.

The example image output also includes an example thermal image 220. The example thermal image 220 includes an object detection 222 and an object 224. The object detector can produce the object detection 222 based on the object 224 (e.g., produced within a range of 5-10 ms after receiving the example thermal image 220). The object detector can cause a processor (e.g., the processor 110 of FIG. 1) to overlay a bounding box representing the object detection 222 in the example thermal image 220. The processor can send a signal to cause a display (e.g., the display 130 of FIG. 1, not shown in FIG. 2) to display the example thermal image 220 including a representation of the object detection 222, such as the bounding box. The processor can track the object 224 in subsequent thermal images using, for example, known object tracking techniques (e.g., as described above). The processor can send a signal to cause the display to update a position of the object detection 222 in response to receiving subsequent thermal images and identifying the object 224 in the subsequent thermal images.

As described herein, the object detector can store data associated with the object detection 212 and the object detection 222 at a memory (e.g., the memory 120 or the memory 174 of FIG. 1), such as dimensions (e.g., a length, width of the object detection 212 and/or the object detection 222) or classifications of the object 214 and/or the object 224.

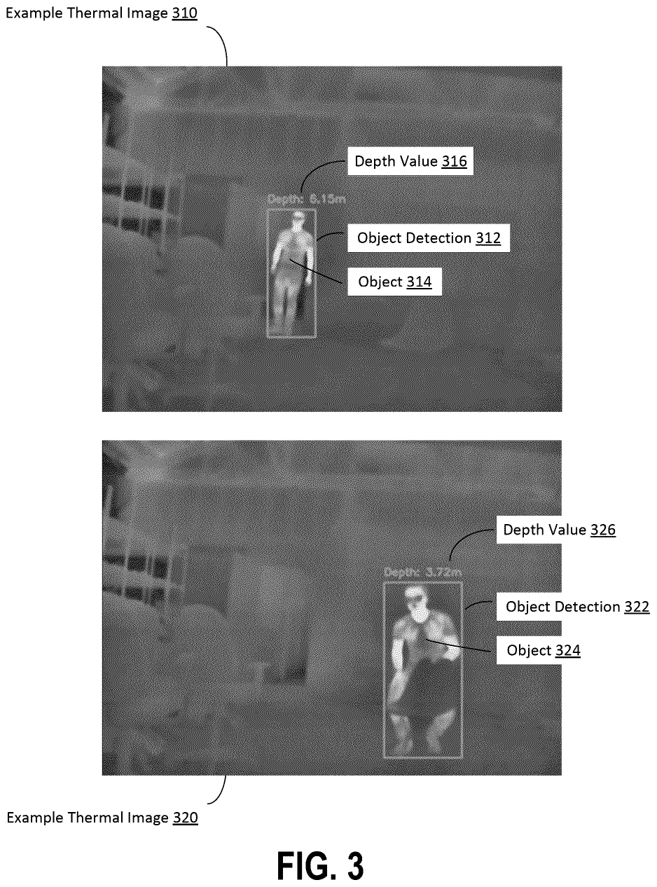

FIG. 3 is an example image output from a depth estimator, according to an embodiment. The depth estimator can be functionally and/or structurally similar to the depth estimator 124 of FIG. 1. The example image output includes an example thermal image 310. The example thermal image 310 includes an object detection 312, an object 314, and a depth value 316. As described herein, the depth estimator can cause a processor (e.g., the processor 110 of FIG. 1) to calculate a depth value 316 for the object 314 associated with the object detection 312 according to an equation (e.g., equation 1 of the present disclosure) based (in some instances, exclusively) on a dimension of the object detection 312, a classification of the object 314, and optical parameters for a thermal camera (e.g., the thermal camera 142 of FIG. 1), such as a focal length. For example, depth value 316 can be based solely on equation 1 and not based on objects other than object 314. The processor (e.g., the processor 110 of FIG. 1) can send a signal to cause a display (e.g., the display 130 of FIG. 1, not shown in FIG. 3) to display the example thermal image 310. The depth estimator can cause the processor to send a signal to the display to overlay text including the depth value 316 in the example thermal image 310. The depth estimator can cause the processor to send a signal to cause the display to update the text of the depth value 316 in response to receiving subsequent thermal images and calculating an updated depth value in the subsequent thermal images. The depth estimator can store the depth value 316 and updated depth value(s) at a memory (e.g., the memory 120 or the memory 174 of FIG. 1).

The example image output also includes an example thermal image 320. The example thermal image 320 includes an object detection 322, and object 324, and a depth value 326. As described herein, the depth estimator can cause a processor (e.g., the processor 110 of FIG. 1) to calculate a depth value 326 for the object 324 associated with the object detection 322 according to an equation (e.g., equation 1 of the present disclosure) based on (and in some instances, exclusively) a dimension of the object detection 322, a classification of the object 324, and optical parameters for a thermal camera (e.g., the thermal camera 142 of FIG. 1), such as a focal length. For example, depth value 316 can be based solely on equation 1 and not based on objects other than object 324. The processor (e.g., the processor 110 of FIG. 1) can send a signal to cause a display (e.g., the display 130 of FIG. 1, not shown in FIG. 3) to display the example thermal image 320. The depth estimator can cause the processor to send a signal to the display to overlay text including the depth value 326 in the example thermal image 320. The depth estimator can cause the processor to send a signal to cause the display to update the text of the depth value 326 in response to receiving subsequent thermal images and calculating an updated depth value in the subsequent thermal images. The depth estimator can store the depth value 326 and updated depth value(s) at a memory (e.g., the memory 120 or the memory 174 of FIG. 1).

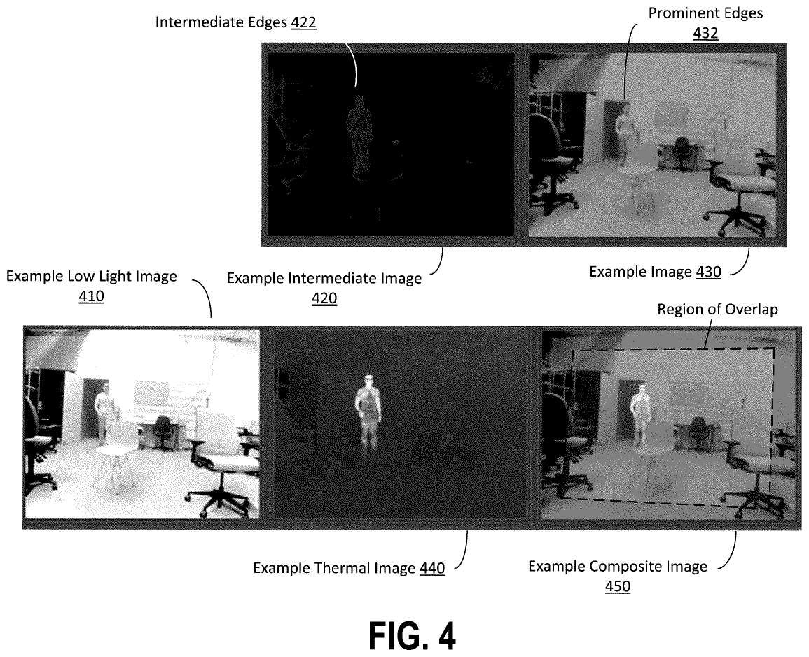

FIG. 4 shows multiple example image outputs from an imaging system for fused mode night vision, according to some embodiments. The imaging system for fused mode night vision can be structurally and/or functionally similar to the imaging system 100 of FIG. 1. The example image outputs include an example low light image 410, an example intermediate image 420, an example image 430, an example thermal image 440, and an example composite image 450. A compute device (e.g., the compute device 102 of FIG. 1) of the imaging system can receive the example low light image 410 from a low light camera (e.g., the low light camera(s) 146 of FIG. 1). The compute device can receive the example thermal image 440 from a thermal camera (e.g., the thermal camera 142 of FIG. 1). The compute device can further process the example low light image 410 and/or the example thermal image 440 to produce any of the example intermediate image 420, the example image 430, and/or the example composite image 450.

In response to receiving the example thermal image 440, an edge detector (e.g., the edge detector 126 of FIG. 1) can cause a processor (e.g., the processor 110 of FIG. 1) to detect edges in the example thermal image 440. The edge detector can cause the processor to render intermediate edges 422 in the example intermediate image 420. The example intermediate image 420 illustrates a spatial distribution of the edges detected in the example thermal image 440. As described herein, the edge detector can cause the processor to further process the spatial distribution of edges in the example intermediate image 420 to produce prominent edges 432 in the example image 430. The processor can send a signal to a display (e.g., the display 130 of FIG. 1) to overlay the prominent edges 432 in the example image 430.

In response to receiving the example low light image 410 and the example thermal image 440, a compositor (e.g., the compositor 128 of FIG. 1) can cause the processor to map pixel coordinates of features (e.g., edges, etc.) in the example low light image 410 to at least one of pixel coordinates of the intermediate edges 422 or pixel coordinates of the prominent edges 432. The compositor can cause the processor to spatially align the example low light image 410 and the example thermal image 440 to produce an (aligned) image stack (not shown in FIG. 4), based on the mapping. The compositor can cause the processor to combine the (aligned) image stack to produce the example composite image 450. In some implementations, the processor can cause the display to also overlay graphic renditions associated with features in the example composite image 450, such as a visual indicator representative of an object (e.g., a bounding box), text representing a depth or classification of the object, and/or the prominent edges 432.

The example composite image 450 includes a region of overlap between a FOV of the low light camera (or visible light camera) and a FOV of the thermal camera. As shown, the region of overlap includes a pixel space associated with the FOV of the thermal camera, which is less than the pixel space associated with the FOV of the low light camera. In some implementations, the FOV of the thermal camera can be greater than the FOV of the low light camera, in which case the region of overlap can include a pixel space associated with the FOV of the low light camera. The region of overlap can be representative of a relative pose between the thermal camera and the low light camera (or visible light camera). As shown, for example, the region of overlap is not coincident with the FOV of the example composite image 450, which indicates that a relative pose exists (e.g., is nonzero) between the thermal camera and the low light camera. In some instances, the region of overlap can be substantially coincident with the FOV of a composite image.

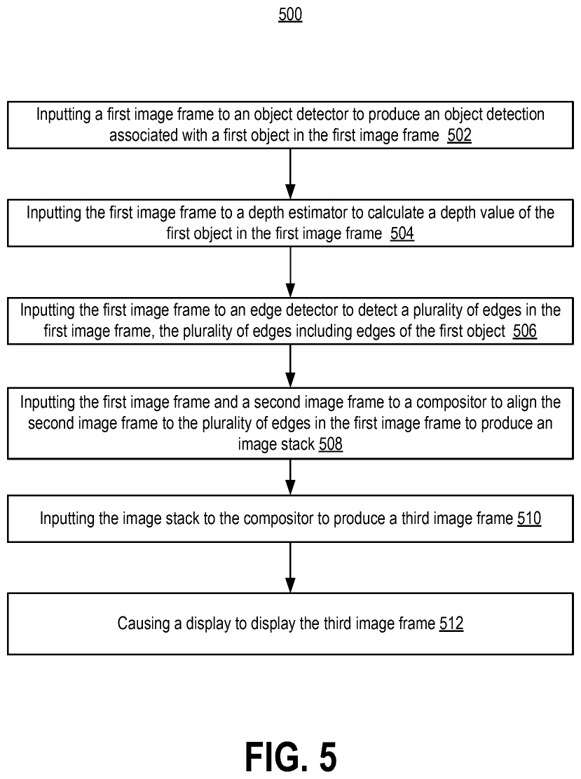

FIG. 5 is an example method 500 for fused mode night vision, according to an embodiment. The example method can be implemented by a compute device (e.g., the compute device 102 of FIG. 1). The example method can be stored as a set of instructions and/or code in a memory (e.g., the memory 120 of FIG. 1) and executed by a processor (e.g., the processor 110 of FIG. 1).

At 502, the example method 500 includes inputting a first image frame to an object detector (e.g., the object detector 122 of FIG. 1) to produce an object detection (e.g., the object detection 212 of FIG. 2) associated with a first object (e.g., the object 214 of FIG. 2) in the first image frame. The object detector can store data associated with the first object and/or the object detection at a memory (e.g., the memory 120 of FIG. 1). In some implementations, the first image frame can be a thermal image frame from a thermal camera (e.g., the thermal camera 142 of FIG. 1). In some implementations, the first image frame can capture a low light or otherwise dark environment. In a low light environment, the object in the thermal image frame can be represented by pixels that collectively have a higher quality than pixels that represent a substantially same object captured by a visible light image frame and/or a low light image frame. In other words, the object can be clearer or otherwise more distinguishable against other objects in the thermal image frame than in the visible image frame and/or in the low light image frame. The object detector can therefore more easily detect and classify objects in a thermal image frame than a visible light image frame and/or a low light image frame in a low light environment. In some implementations, the object detection can include a classification of the object.

At 504, the example method 500 includes inputting the first image frame to a depth estimator (e.g., the depth estimator 124 of FIG. 1) to calculate a depth value (e.g., the depth value 316 of FIG. 3) of the first object in the first image frame. The depth estimator can calculate the depth value from, for example, an estimated width value based on the classification of the object, a width value of the object detection, and a focal length of the camera that captured the first image frame (e.g., the thermal camera 142 of FIG. 1).

At 506, the example method 500 includes inputting the first image frame to an edge detector (e.g., the edge detector 126 of FIG. 1) to detect a plurality of edges in the first image frame, the plurality of edges including edges of the first object. As described herein, the edge detector can process the first image frame to detect the plurality of edges using a smoothing function, gradient calculations, non-maximum suppression, double thresholding, and/or edge tracking by hysteresis.

At 508, the example method 500 includes inputting the first image frame and a second image frame to a compositor (e.g., the compositor 128 of FIG. 1) to align the second image frame to the plurality of edges in the first image frame to produce an image stack. In some implementations, the second image frame can be a low light image frame from a low light camera (e.g., the low light camera(s) 146 of FIG. 1). In some implementations, the second image frame can be a visible light image frame from a visible light camera (e.g., the visible light camera(s) 144 of FIG. 1).

At 510, the example method 500 includes inputting the image stack to the compositor to produce a third image frame. The third image frame can be a composite image combining the first image frame and the second image frame of the image stack. The third image frame can emphasize the first object, the plurality of edges, and other features of the surrounding environment.

At 512, the example method 500 includes causing a display (e.g., the display 130 of FIG. 1) to display the third image frame. In some implementations, the compute device (e.g., the compute device 102 of FIG. 1) can cause the display to display the third image frame in substantially real-time (e.g., with little to no perceivable delay, for example in less than 100 ms) relative to receiving the first image frame and the second image frame. The real-time display of images can be facilitated by the fast computation times of the object detector, the depth estimator, the edge detector, and/or the compositor of the compute device.

In some implementations, the example method 500 can include causing the display to display the first image frame and/or the second image frame, for example, in response to a failure of the first camera, the second camera, or the compositor to produce the third image frame. For example, if the first camera were to drop in quality (e.g., due to an obstruction, dust, etc.) or fail, then the processor of the compute device can cause the display to display the second image frame. Similarly, if the second camera were to drop in quality or fail, then the processor can cause the display to display the first image frame.

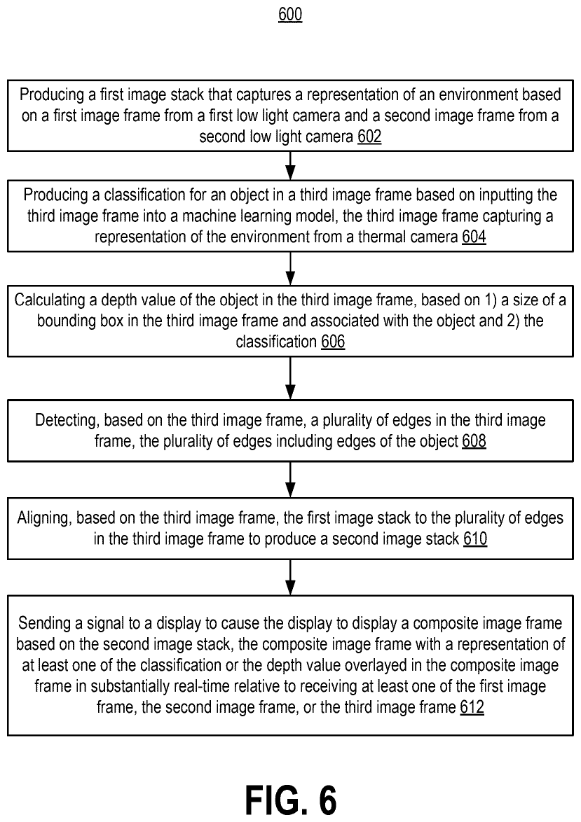

FIG. 6 shows a flow diagram of a method 600 for fused mode night vision, according to an embodiment. In some implementations, the method 600 can be stored in a memory (e.g., the memory 120 of FIG. 1) as instructions that can be executed by a processor (e.g., the processor 110 of FIG. 1).

At 602, the method 600 includes producing a first image stack that captures a representation of an environment based on a first image frame from a first low light camera and a second image frame from a second low light camera. Producing the first image stack can include, for example, spatially aligning the first image frame with the second image frame. Spatial alignment of multiple low light images (and/or visible light images) can, for example, increase a spatial resolution, increase a brightness or contrast, or otherwise improve a quality of outputs from the method 600 by generating the outputs from an image stack that itself has a higher spatial resolution, better brightness and/or contrast, or other attribute than individual low light images (and/or visible light images) alone. The first image stack can be, for example, a homography of the first image frame and the second image frame.

At 604, the method 600 includes producing a classification for an object in a third image frame (e.g., example thermal image 210 of FIG. 2, example thermal image 220 of FIG. 2) based on inputting the third image frame into a machine learning model (e.g., object detector 122 of FIG. 1), the third image frame capturing a representation of the environment from a thermal camera (e.g., thermal camera 142 of FIG. 1). In some implementations, the machine learning model can produce the classification within a range of 5-10 ms of receiving the third image frame. In some implementations, the method 600 can include causing display of a visual indicator that represents the object and in the third image frame. In some implementations, the method 600 can include causing or restricting display of a visual indicator that represents the object and in the third image frame, based on the classification for the object, as described elsewhere herein.

At 606, the method 600 includes calculating a depth value of the object in the third image frame, based on 1) a size of a bounding box in the third image frame and associated with the object and 2) the classification. Calculating can include, for example, providing the third image frame as input to a depth estimator (e.g., depth estimator 124 of FIG. 1) to cause the depth estimator to calculate the depth value according to equation 1 of the present disclosure. In some implementations, the bounding box can have a substantially rectangular shape with a length and a width. A bounding box can be a coarse representation of the object detection. In some implementations, the method 600 can alternatively include calculating the depth value based on a size of a shape other than the bounding box in the third image frame and that represents the object. For example, the method 600 can include generating an outline that more finely matches the true pixel extent of the object. In some implementations, the method 600 can include causing or restricting display of the depth value based on how close (or far) the depth value indicates the object is to the location of the thermal camera.

At 608, the method 600 includes detecting, based on the third image frame, a plurality of edges in the third image frame, the plurality of edges including edges of the object. Detecting can include, for example, providing the third image frame as input to an edge detector (e.g., the edge detector 126 of FIG. 1) to detect the plurality of edges.

At 610, the method 600 includes aligning, based on the third image frame, the first image stack to the plurality of edges in the third image frame to produce a second image stack. Aligning can include, for example, providing the third image frame and the first image stack to a compositor (e.g., the compositor 128 of FIG. 1) to cause the compositor to produce the second image stack. The second image stack can be, for example, a homography of the first image stack and the third image frame.

At 612, the method 600 includes sending a signal to a display (e.g., display 130 of FIG. 1) to cause the display to display a composite image frame based on the second image stack, the composite image frame with a representation of at least one of the classification or the depth value overlayed in the composite image frame in substantially real-time relative to receiving at least one of the first image frame, the second image frame, or the third image frame. In a low light environment, for example, a user can more easily visually parse the composite image frame than, for example, the first image frame, the second image frame, the first image stack, the third image frame, or the second image stack alone, to rapidly identify objects of importance and information about the objects of importance. The method 600 can be a fast, computationally efficient, and “on-edge” method to identify such objects and such information.

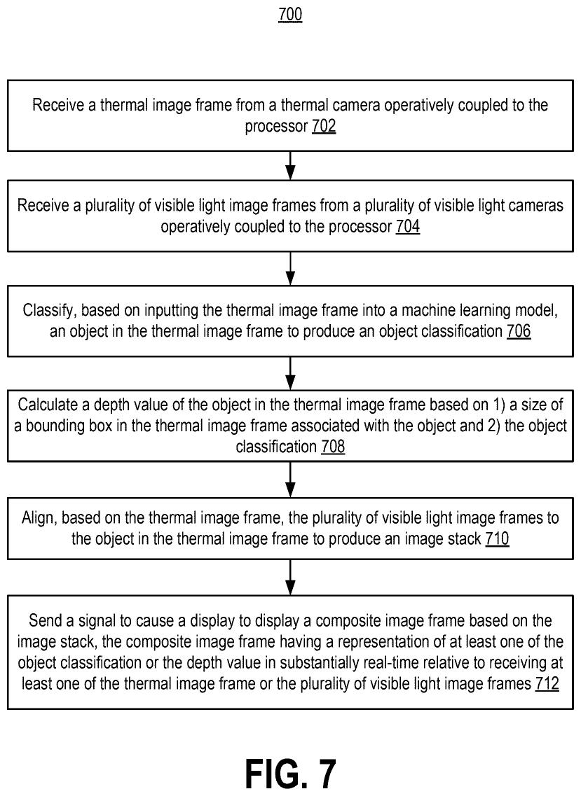

FIG. 7 shows a method 700 for fused mode night vision, according to an embodiment. In some implementations, the method 700 can be stored in a memory (e.g., the memory 120 of FIG. 1) as instructions that can be executed by a processor (e.g., the processor 110 of FIG. 1).

At 702, the method 700 includes receiving a thermal image frame (e.g., example thermal image 210 of FIG. 2, example thermal image 220 of FIG. 2) from a thermal camera (e.g., thermal camera 142 of FIG. 1) operatively coupled to the processor.

At 704, the method 700 includes receiving a plurality of visible light image frames from a plurality of visible light cameras (e.g., visible light camera(s) 144 of FIG. 1) operatively coupled to the processor. At least a subset of the visible light images from the plurality of visible light images can share a region of overlap with the thermal image frame.

At 706, the method 700 includes classifying, based on inputting the thermal image frame into a machine learning model, an object in the thermal image frame to produce an object classification. Classifying can include, for example, providing the thermal image frame as input to an object detector (e.g., the object detector 122 of FIG. 1) to cause the object detector to produce the object classification. In some implementations, the machine learning model can produce the classification within a range of 5-10 ms of receiving the third image frame. In some implementations, the method 700 can include causing display of a visual indicator that represents the object and in the thermal image frame. In some implementations, the method 700 can include causing or restricting display of a visual indicator that represents the object and in the thermal image frame, based on the classification for the object, as described elsewhere herein.

At 708, the method 700 includes calculating a depth value of the object in the thermal image frame based on 1) a size of a bounding box in the thermal image frame associated with the object and 2) the object classification. Calculating can include, for example, providing the thermal image frame as input to a depth estimator (e.g., depth estimator 124 of FIG. 1) to cause the depth estimator to calculate the depth value according to equation 1 of the present disclosure. In some implementations, the bounding box can have a substantially rectangular shape with a length and a width. A bounding box can be a coarse representation of the object detection. In some implementations, the method 700 can alternatively include calculating the depth value based on a size of a shape other than the bounding box in the thermal image frame and that represents the object. For example, the method 700 can include generating an outline that more finely matches the true pixel extent of the object. In some implementations, the method 700 can include causing or restricting display of the depth value based on how close (or far) the depth value indicates the object is to the location of the thermal camera.

At 710, the method 700 includes aligning, based on the thermal image frame, the plurality of visible light image frames to the object in the thermal image frame to produce an image stack. Aligning can include, for example, providing the thermal image frame and the plurality of visible light image frames as input to an edge detector (e.g., the edge detector 126 of FIG. 1) to cause the edge detector to align edges in the thermal image frame to features in the plurality of visible light image frames. The image stack can be, for example, a homography of the thermal image frame and the plurality of visible light image frames.

At 712, the method 700 includes sending a signal to cause a display to display a composite image frame based on the image stack, the composite image frame having a representation of at least one of the object classification or the depth value in substantially real-time relative to receiving at least one of the thermal image frame or the plurality of visible light image frames. In a low light environment, for example, a user can more easily visually parse the composite image frame than, for example, the thermal image frame, the plurality of visible light images, or the image stack alone, to rapidly identify objects of importance and information about the objects of importance. The method 600 can be a fast, computationally efficient, and “on-edge” method to identify such objects and such information.

In some embodiments, an apparatus comprises: a thermal camera configured to capture a thermal image frame of an environment; a low light camera configured to capture a low light image frame of the environment; and a compute device including a display, a processor, and a memory, the compute device being communicatively coupled to the thermal camera and the low light camera, the memory storing instructions that when executed by the processor cause the processor to: detect, based on the thermal image frame, a plurality of edges in the thermal image frame; align, based on the thermal image frame, the low light image frame to the plurality of edges in the thermal image frame to produce an image stack; and cause the display to display a composite image frame based on the image stack in substantially real-time relative to receiving at least one of the thermal image frame or the low light image frame.

In some such implementations, the compute device is included within a head mounted display, the thermal camera and the low light camera are connected to the head mounted display, the head mounted display is configured to be worn by a user.

In some such implementations, the memory stores further instructions that cause the processor further to: classify, based on a machine learning model, an object in the thermal image frame to produce an object classification; calculate a depth value of the object in the thermal image frame, based on (i) a size of a bounding box in the thermal image frame and associated with the object, (ii) the object classification, and (iii) an optical parameter of the thermal camera; and cause the display to display a representation of the object classification in the composite image frame.

In some such implementations, the memory stores further instructions that cause the processor further to: classify, based on a machine learning model, a first object in the thermal image frame to produce an object classification; calculate a depth value of the first object in the thermal image frame, based on (i) a size of a bounding box in the thermal image frame and associated with the first object, (ii) the object classification, and (iii) an optical parameter of the thermal camera, the depth value not based on a second object in the thermal image frame different from the first object; and cause the display to display a representation of the object classification in the composite image frame.

In some such implementations, the apparatus further comprises: a second low light camera configured to capture a second low light image frame of the environment, the second low light camera being communicatively coupled to the compute device, the low light camera being a first low light camera, the low light image frame being a first low light image frame, the image stack being a first image stack, the composite image frame being a first composite image frame, the memory storing further instructions that when executed by the processor cause the processor further to: align, based on the second low light image frame, the first low light image frame to the second low light image frame to produce a second image stack; align, based on the thermal image frame, the second image stack to the plurality of edges in the thermal image frame to produce a third image stack; and cause the display to display a second composite image frame based on the third image stack.

In some such implementations, the memory stores further instructions that cause the processor further to: classify, based on a machine learning model, an object in the thermal image frame to produce an object classification; calculate a depth value of the object in the thermal image frame, based exclusively on (i) a size of a bounding box in the thermal image frame and associated with the object, (ii) the object classification, and (iii) an optical parameter of the thermal camera; and cause the display to display a representation of the object classification in the composite image frame.

In some such implementations, the memory stores further instructions that when executed by the processor cause the processor further to: classify, based on a machine learning model, an object in the thermal image frame to produce an object classification; calculate a depth value of the object in the thermal image frame, based on (i) a size of a bounding box in the thermal image frame and associated with the object, (ii) the object classification, and (iii) an optical parameter of the thermal camera; cause the display to display a representation of the object classification in the composite image frame; and cause the display to overlay a visual indicator associated with the object in the composite image frame.

In some embodiments, a method comprises: producing a first image stack that captures a representation of an environment based on a first image frame from a first low light camera and a second image frame from a second low light camera; producing a classification for an object in a third image frame based on inputting the third image frame into a machine learning model, the third image frame capturing a representation of the environment from a thermal camera; calculating a depth value of the object in the third image frame, based on (i) a size of a bounding box in the third image frame and associated with the object, (ii) the classification, and (iii) an optical parameter of the thermal camera; detecting, based on the third image frame, a plurality of edges in the third image frame, the plurality of edges including edges of the object; aligning, based on the third image frame, the first image stack to the plurality of edges in the third image frame to produce a second image stack; and sending a signal to a display to cause the display to display a composite image frame based on the second image stack, the composite image frame with a representation of at least one of the classification or the depth value overlayed in the composite image frame in substantially real-time relative to receiving at least one of the first image frame, the second image frame, or the third image frame.

In some such implementations, the display is included with a head mounted display, the thermal camera, the first low light camera, and the second low light camera are connected to the head mounted display, the head mounted display is configured to be worn by a user.

In some such implementations, the machine learning model is a You Only Look Once (YOLO) machine learning model that produces the classification within a range of 5-10 ms of receiving the third image frame.

In some such implementations, the method further comprises: causing the display to overlay at least one of the plurality of edges in the composite image frame or a second bounding box associated with the object in the composite image frame, the bounding box being a first bounding box.

In some such implementations, the composite image frame is a first composite image frame, the method further comprising: in response to a failure of the first low light camera, producing a second composite image frame based on the second image frame and the third image frame; and causing the display to display the second composite image frame in substantially real-time relative to receiving at least one of the second image frame or the third image frame.

In some such implementations, the object is a first object, and the depth value is not based on a second object in the thermal image frame different from the first object.

In some such implementations, the plurality of edges includes at least one of a plurality of strong edges or a plurality of weak edges connected to the plurality of strong edges.

In some embodiments, a non-transitory, processor-readable medium stores instructions that, when executed by a processor, cause the processor to: receive a thermal image frame from a thermal camera operatively coupled to the processor; receive a plurality of visible light image frames from a plurality of visible light cameras operatively coupled to the processor; classify, based on inputting the thermal image frame into a machine learning model, an object in the thermal image frame to produce an object classification; calculate a depth value of the object in the thermal image frame based on (i) a size of a bounding box in the thermal image frame associated with the object, (ii) the object classification, and (iii) an optical parameter of the thermal camera; align, based on the thermal image frame, the plurality of visible light image frames to the object in the thermal image frame to produce an image stack; and send a signal to cause a display to display of a composite image frame based on the image stack, the composite image frame having a representation of at least one of the object classification or the depth value in substantially real-time relative to receiving at least one of the thermal image frame or the plurality of visible light image frames.

In some such implementations, the thermal image frame is a first thermal image frame, the depth value is a first depth value, the size is a first size, the bounding box is a first bounding box, the plurality of visible light image frames is a first plurality of visible light image frames, the image stack is a first image stack, the composite image frame is a first composite image frame, the non-transitory, processor-readable medium storing further instructions that, when executed by the processor, cause the processor further to: identify the object in a second thermal image frame generated subsequent to the first thermal image frame; calculate a second depth value of the object in the second thermal image frame based on 1) a second size of a second bounding box in the second thermal image frame associated with the object and 2) the object classification; align, based on the second thermal image frame, a second plurality of visible light image frames to the object in the second thermal image frame to produce a second image stack, the second plurality of visible light image frames being generated subsequent to the first plurality of visible light image frames; and send a signal to cause display of a second composite image frame based on the second image stack, the second composite image frame having a representation of the second depth value in the second composite image frame in substantially real-time relative to identifying the object in the second thermal image frame.

In some such implementations, the processor is operatively coupled to a head mounted display, the head mounted display is connected to the thermal camera and the plurality of visible light cameras, and the display is a display of the head mounted display.

Clause 18. The non-transitory, processor-readable medium of clause 15, wherein: the thermal image frame and the plurality of visible light image frames capture a representation of a low light environment having the object, and the object in the thermal image frame has a first plurality of pixels with a quality higher than a quality of a second plurality of pixels associated with the object in the plurality of visible light image frames.

In some such implementations, the machine learning model is configured to produce the object classification within a range of 5-10 ms of a transmission from the thermal camera operatively coupled to the processor.

In some such implementations, the object is at least one of a human, a vehicle, or a vessel.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a thermal camera configured to capture a thermal image frame of an environment;
a low light camera configured to capture a low light image frame of the environment; and
a compute device including a display, a processor, and a memory, the compute device being communicatively coupled to the thermal camera and the low light camera,
the memory storing instructions that when executed by the processor cause the processor to:
detect, based on the thermal image frame, a plurality of edges in the thermal image frame;
align, based on the thermal image frame, the low light image frame to the plurality of edges in the thermal image frame to produce an image stack; and
cause the display to display a composite image frame based on the image stack in substantially real-time relative to receiving at least one of the thermal image frame or the low light image frame.

2. The apparatus of claim 1, wherein:
the compute device is included within a head mounted display,
the thermal camera and the low light camera are connected to the head mounted display,
the head mounted display is configured to be worn by a user.

3. The apparatus of claim 1, wherein the memory stores further instructions that cause the processor further to:
classify, based on a machine learning model, an object in the thermal image frame to produce an object classification;
calculate a depth value of the object in the thermal image frame, based on (i) a size of a bounding box in the thermal image frame and associated with the object, (ii) the object classification, and (iii) an optical parameter of the thermal camera; and
cause the display to display a representation of the object classification in the composite image frame.

4. The apparatus of claim 1, wherein the memory stores further instructions that cause the processor further to:
classify, based on a machine learning model, a first object in the thermal image frame to produce an object classification;
calculate a depth value of the first object in the thermal image frame, based on (i) a size of a bounding box in the thermal image frame and associated with the first object, (ii) the object classification, and (iii) an optical parameter of the thermal camera, the depth value not based on a second object in the thermal image frame different from the first object; and
cause the display to display a representation of the object classification in the composite image frame.

5. The apparatus of claim 1, further comprising:
a second low light camera configured to capture a second low light image frame of the environment, the second low light camera being communicatively coupled to the compute device,
the low light camera being a first low light camera,
the low light image frame being a first low light image frame,
the image stack being a first image stack,
the composite image frame being a first composite image frame,
the memory storing further instructions that when executed by the processor cause the processor further to:
align, based on the second low light image frame, the first low light image frame to the second low light image frame to produce a second image stack;
align, based on the thermal image frame, the second image stack to the plurality of edges in the thermal image frame to produce a third image stack; and
cause the display to display a second composite image frame based on the third image stack.

6. The apparatus of claim 1, wherein the memory stores further instructions that cause the processor further to:
classify, based on a machine learning model, an object in the thermal image frame to produce an object classification;
calculate a depth value of the object in the thermal image frame, based exclusively on (i) a size of a bounding box in the thermal image frame and associated with the object, (ii) the object classification, and (iii) an optical parameter of the thermal camera; and
cause the display to display a representation of the object classification in the composite image frame.

7. The apparatus of claim 1, wherein the memory stores further instructions that when executed by the processor cause the processor further to:
classify, based on a machine learning model, an object in the thermal image frame to produce an object classification;
calculate a depth value of the object in the thermal image frame, based on (i) a size of a bounding box in the thermal image frame and associated with the object, (ii) the object classification, and (iii) an optical parameter of the thermal camera;
cause the display to display a representation of the object classification in the composite image frame; and
cause the display to overlay a visual indicator associated with the object in the composite image frame.

8. A method, comprising:
producing a first image stack that captures a representation of an environment based on a first image frame from a first low light camera and a second image frame from a second low light camera;
producing a classification for an object in a third image frame based on inputting the third image frame into a machine learning model, the third image frame capturing a representation of the environment from a thermal camera;
calculating a depth value of the object in the third image frame, based on (i) a size of a bounding box in the third image frame and associated with the object, (ii) the classification, and (iii) an optical parameter of the thermal camera;
detecting, based on the third image frame, a plurality of edges in the third image frame, the plurality of edges including edges of the object;
aligning, based on the third image frame, the first image stack to the plurality of edges in the third image frame to produce a second image stack; and
sending a signal to a display to cause the display to display a composite image frame based on the second image stack, the composite image frame with a representation of at least one of the classification or the depth value overlayed in the composite image frame in substantially real-time relative to receiving at least one of the first image frame, the second image frame, or the third image frame.

9. The method of claim 8, wherein:
the display is included with a head mounted display,
the thermal camera, the first low light camera, and the second low light camera are connected to the head mounted display,
the head mounted display is configured to be worn by a user.

10. The method of claim 8, wherein:
the machine learning model is a You Only Look Once (YOLO) machine learning model that produces the classification within a range of 5-10 ms of receiving the third image frame.

11. The method of claim 8, further comprising:
causing the display to overlay at least one of the plurality of edges in the composite image frame or a second bounding box associated with the object in the composite image frame,
the bounding box being a first bounding box.

12. The method of claim 8, wherein the composite image frame is a first composite image frame, the method further comprising:
in response to a failure of the first low light camera, producing a second composite image frame based on the second image frame and the third image frame; and
causing the display to display the second composite image frame in substantially real-time relative to receiving at least one of the second image frame or the third image frame.

13. The method of claim 8, wherein:
the object is a first object, and
the depth value is not based on a second object in the thermal image frame different from the first object.

14. The method of claim 8, wherein the plurality of edges includes at least one of a plurality of strong edges or a plurality of weak edges connected to the plurality of strong edges.

15. A non-transitory, processor-readable medium storing instructions that, when executed by a processor, cause the processor to:
receive a thermal image frame from a thermal camera operatively coupled to the processor;
receive a plurality of visible light image frames from a plurality of visible light cameras operatively coupled to the processor;
classify, based on inputting the thermal image frame into a machine learning model, an object in the thermal image frame to produce an object classification;
calculate a depth value of the object in the thermal image frame based on (i) a size of a bounding box in the thermal image frame associated with the object, (ii) the object classification, and (iii) an optical parameter of the thermal camera;
align, based on the thermal image frame, the plurality of visible light image frames to the object in the thermal image frame to produce an image stack; and
send a signal to cause a display to display of a composite image frame based on the image stack, the composite image frame having a representation of at least one of the object classification or the depth value in substantially real-time relative to receiving at least one of the thermal image frame or the plurality of visible light image frames.

16. The non-transitory, processor-readable medium of claim 15, wherein the thermal image frame is a first thermal image frame, the depth value is a first depth value, the size is a first size, the bounding box is a first bounding box, the plurality of visible light image frames is a first plurality of visible light image frames, the image stack is a first image stack, the composite image frame is a first composite image frame, the non-transitory, processor-readable medium storing further instructions that, when executed by the processor, cause the processor further to:
identify the object in a second thermal image frame generated subsequent to the first thermal image frame;
calculate a second depth value of the object in the second thermal image frame based on 1) a second size of a second bounding box in the second thermal image frame associated with the object and 2) the object classification;
align, based on the second thermal image frame, a second plurality of visible light image frames to the object in the second thermal image frame to produce a second image stack, the second plurality of visible light image frames being generated subsequent to the first plurality of visible light image frames; and
send a signal to cause display of a second composite image frame based on the second image stack, the second composite image frame having a representation of the second depth value in the second composite image frame in substantially real-time relative to identifying the object in the second thermal image frame.

17. The non-transitory, processor-readable medium of claim 15, wherein:
the processor is operatively coupled to a head mounted display,
the head mounted display is connected to the thermal camera and the plurality of visible light cameras, and
the display is a display of the head mounted display.

18. The non-transitory, processor-readable medium of claim 15, wherein:
the thermal image frame and the plurality of visible light image frames capture a representation of a low light environment having the object, and
the object in the thermal image frame has a first plurality of pixels with a quality higher than a quality of a second plurality of pixels associated with the object in the plurality of visible light image frames.

19. The non-transitory, processor-readable medium of claim 15, wherein:
the machine learning model is configured to produce the object classification within a range of 5-10 ms of a transmission from the thermal camera operatively coupled to the processor.

20. The non-transitory, processor-readable medium of claim 15, wherein the object is at least one of a human, a vehicle, or a vessel.
